(19) United States
(12) Patent Application Publication
(10) Pub. No.: US 2026/0273682 A1
(43) Pub. Date: Sep. 17, 2026

(54) ABNORMAL LOAD DETECTION DEVICE, ABNORMAL LOAD DETECTION METHOD, AND ABNORMAL LOAD DETECTION PROGRAM

(71) Applicant: Fanuc Corporation, Minamitsuru-gun, Yamanashi (JP)

(72) Inventor: Tsutomu NAKAMURA, Minamitsuru-gun, Yamanashi (JP)

(73) Assignee: Fanuc Corporation, Minamitsuru-gun, Yamanashi (JP)

(21) Appl. No.: 19/471,479

(22) PCT Filed: May 17, 2023
(86) PCT No.: PCT/JP2023/018421

§ 371 Date: Oct. 1, 2025

(51) Int. Cl. B23Q 17/09; G05B 19/406

(52) U.S. Cl. CPC B23Q 17/0952; G05B 19/406; G05B 2219/34465

(57) ABSTRACT

Provided is an abnormal load detection device that detects an abnormal load condition of a shaft in a machine tool. A movement instructions generation unit generates movement instructions for the shaft on the basis of a machining program, and a predicted load calculation unit calculates a predicted load which is to be applied the shaft. A movement control unit controls the movement of the shaft on the basis of the movement instructions, and an actual load calculation unit calculates the actual load which is actually applied to the shaft. A difference apparatus calculates a load prediction error, which is the difference between the predicted load and the actual load, and an abnormal load detector detects an abnormal load condition of the shaft on the basis of the load prediction error.

### CROSS REFERENCE TO RELATED APPLICATIONS

This is the U.S. National Phase application of PCT/JP2023/018421, filed May 17, 2023, the disclosure of this application being incorporated herein by reference in its entirety for all purposes.

### FIELD OF THE INVENTION

The present disclosure relates to an abnormal load detection device, an abnormal load detection method, and an abnormal load detection program.

### BACKGROUND OF THE INVENTION

Conventionally, for example, a machine tool controlled by a numerical control device (NC (Numerical Control) device) has a plurality of drive axes driven by motors, and an abnormal load torque of each axis is detected by an abnormal load detection device. Specifically, the abnormal load detection device detects an abnormal load condition of an axis in a machine tool having at least one axis. Note that the abnormal load condition of the axis occurs due to a fluctuation in load torque caused by multiple factors such as cutting speed and cutting depth, and occurs due to, for example, a collision of a machine, a failure of a byte, damage, or the like.

Note that, in the present specification, the numerical control device (NC device) also includes a computer numerical control device (C (Computerized) NC device). Further, machine tools (numerical control machine tools) may include various types of machines, such as a lathe, a ball board, a boring board, a milling machine, a grinder, a gear finishing machine, a machining center, a discharge machine, a punch press, a laser processing machine, a carrier, and a plastic injection molding machine.

Incidentally, various proposals have been made so far as abnormal load detection devices (numerical control devices) capable of detecting abnormal load torque (abnormal load).

### Patent Literature

[PTL 1] International Patent Publication No. 2022-162740

[PTL 2] Japanese Unexamined Patent Publication (Kokai) No. H06(1994)-289917

### SUMMARY

As described above, although various proposals have been made as an abnormal load detection device capable of detecting an abnormal load, these abnormal load detection devices detect an abnormal load condition of the axis based on, for example, a load torque based on a speed command or an acceleration command of the motor and an actual torque or the like of a motor provided on each axis of the machine tool.

Specifically, the conventional abnormal load detection device detects an abnormal load by, for example, comparing the actual torque with a value (threshold value) obtained by adding a torque value considered appropriate in consideration of a predetermined offset (margin) to a torque value specific to the motor. Therefore, it was difficult for the conventional abnormal load detection device to detect an abnormal load with high sensitivity.

Therefore, there is a demand for providing an abnormal load detection device, an abnormal load detection method, and an abnormal load detection program that may improve the detection sensitivity of an abnormal load.

According to an embodiment of the present disclosure, there is provided an abnormal load detection device for detecting an abnormal load condition of an axis in a machine tool having at least one axis, including a movement command generation unit, a predicted load calculation unit, a movement control unit, an actual load calculation unit, a difference device, and an abnormal load detector.

The movement command generation unit generates a movement command of the axis on the basis of a machining program, and the predicted load calculation unit calculates a prediction load applied to the axis on the basis of the machining program. The movement control unit controls a movement of the axis on the basis of the movement command, and the actual load calculation unit calculates an actual load actually applied to the axis on the basis of the movement command and movement control information used for a movement control of the axis. The difference device calculates a load prediction error that is a difference between the prediction load and the actual load, and the abnormal load detector detects an abnormal load condition of the axis on the basis of the load prediction error.

### BRIEF DESCRIPTION OF DRAWINGS

FIG. 1 is a block diagram for explaining a main part of an example of a machine tool and a numerical control device.

FIG. 2 is a block diagram schematically depicting an example of a numerical control device depicted in FIG. 1.

FIG. 3 is a functional block diagram depicting an example of an abnormal load detection device.

FIG. 4 is a diagram for explaining an abnormal load detection by the abnormal load detection device depicted in FIG. 3.

FIG. 5 is a functional block diagram depicting an example of an abnormal load detection device according to the present embodiment.

FIG. 6 is a diagram for explaining an abnormal load detection by the abnormal load detection device illustrated in FIG. 5.

### DETAILED DESCRIPTION OF EMBODIMENTS OF THE INVENTION

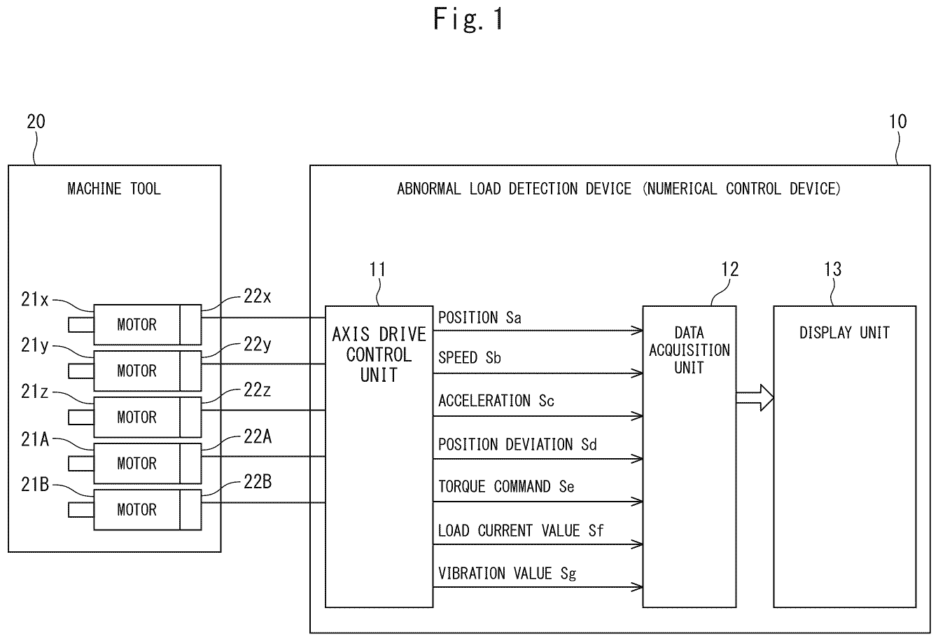

First, an example of an abnormal load detection device (numerical control device) and its problem will be described with reference to FIG. 1 to FIG. 4 prior to detailed examples of an abnormal load detection device, an abnormal load detection method, and an abnormal load detection program according to the present embodiment.

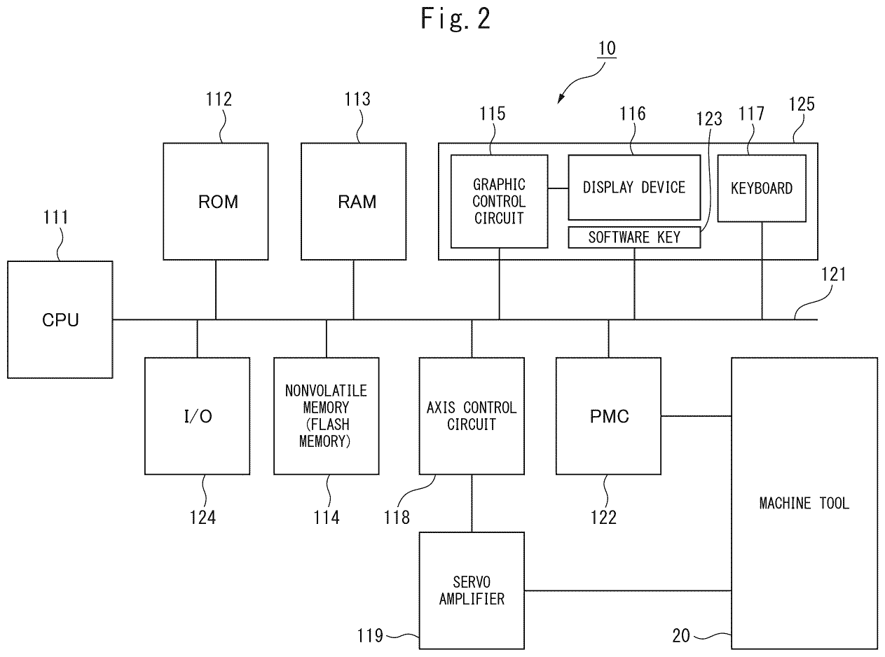

FIG. 1 is a block diagram for explaining a main part of an example of a machine tool and a numerical control device, and FIG. 2 is a block diagram schematically depicting an example of a numerical control device depicted in FIG. 1. Note that the abnormal load detection device according to the present embodiment corresponds to, for example, the numerical control device 10 in FIG. 1 and FIG. 2, but does not necessarily have all the configurations of the numerical control device 10. Specifically, the abnormal load detection device according to the present embodiment may be configured integrally with, for example, a numerical control device, but is not limited to an integrated configuration.

As illustrated in FIG. 1, the numerical control device (NC device, CNC device: abnormal load detection device) 10 includes, for example, an axis drive control unit 11, a data acquisition unit 12, and a display unit 13. The machine tool 20 includes, for example, servo motors 21x, 21y, 21z, 21A, 21B that drive a feed axis. The servo motors 21x, 21y, 21z, 21A, 21B are driven and controlled via a servo amplifier (e.g. corresponding to the servo amplifier 119 in FIG. 2) based on torque commands from the axis drive control unit 11 of the numerical control device 10.

Note that the load torque described in this specification corresponds to, for example, a load current for driving each of the servo motors 21x, 21y, 21z, 21A, 21B. Further, each of the servo motors 21x, 21y, 21z, 21A, 21B is provided with a position detection device 22x, 22y, 22z, 22A, 22B, and the position information of each servo motor 21x, 21y, 21z, 21A, 21B (21) is fed back to the axis drive control unit 11 from the position detection devices 22x, 22y, 22z, 22A, 22B.

For example, the axis drive control unit 11 outputs various types of information based on the movement command output from the movement command generation unit (10a) that analyzes and processes a machining program (2) of the numerical control device 10 and the position information Sa fed back from the servo motor 21. Specifically, for example, the axis drive control unit 11 acquires the speed information Sb, the acceleration information Sc, the torque command Se of each drive axis, the acquisition of the load current value Sf applied to the servo amplifier, the acquisition of the vibration value Sg from the impact sensor attached to each spindle motor, and outputs the vibration value Sg to the data acquisition unit 12 together with the feedback position information Sa.

The data acquisition unit 12 simultaneously acquires various types of information from the axis drive control unit 11 for each predetermined time. The data acquisition unit 12 may simultaneously acquire various types of information from the axis drive control unit 11 for each predetermined time, and acquire a block number or the like during execution of the machining program that may be acquired in the numerical control device 10.

As depicted in FIG. 2, the numerical control device 10 includes, for example, a CPU (Central Processing Unit: processor) 111 connected by a bus 121, a ROM (Read Only Memory) 112, a RAM (Random Access Memory) 113, an I/O (Input/Output) 124, a non-volatile memory 114 (e.g., a flash memory), an axis control circuit 118, and a PMC (programmable machine controller) 122. Further, for example, the bus 121 is also connected with a graphic control circuit 115, a software key 123, a keyboard 117, and the like of a display device/MDI (Manual Data Input) panel 125. Here, the display device/MDI panel 125 is provided with a display device 116 such as a liquid crystal display (LCD) and the like coupled to the graphic control circuit 115. Note that, the machine tool 20 (motor provided in the machine tool) is controlled by, for example, a PMC 122, and a servo amplifier 119 connected to the axis control circuit 118.

The CPU 111 controls, for example, the entire numerical control device 10 according to the system program stored in the ROM 112. Various data or input/output signals are stored in the RAM 113, and various kinds of information of position information, speed information, acceleration information, position deviation, torque command, load current value, and vibration value are stored in time series on the basis of time information acquired by them, for example.

The graphic control circuit 115 converts the digital signal into a display signal and gives it to the display device 116, and the keyboard 117 inputs various setting data having a numerical key, a character key, and the like. The axis control circuit 118 receives the movement command of each axis from the CPU 111, outputs the command of the axis to the servo amplifier 119, and the servo amplifier 119 drives the servo motors 21 provided in the machine tool 20 based on the movement command from the axis control circuit 118.

When executing the machining program, the PMC 122 receives a T-function signal (tool selection command) or the like via the bus 121, processes the signal with a sequence program, and controls the machine tool 20 as an operation command. Further, the PMC 122 receives the state signal from the machine tool 20 and transfers a predetermined input signal to the CPU 111. Note that the function of the software key 123 changes by, for example, a system program or the like and the I/O (interface) 124 sends the NC data to an external storage device or the like. In the above, FIG. 1 and FIG. 2 depict merely examples, and it may not be said that various modifications and changes may be possible.

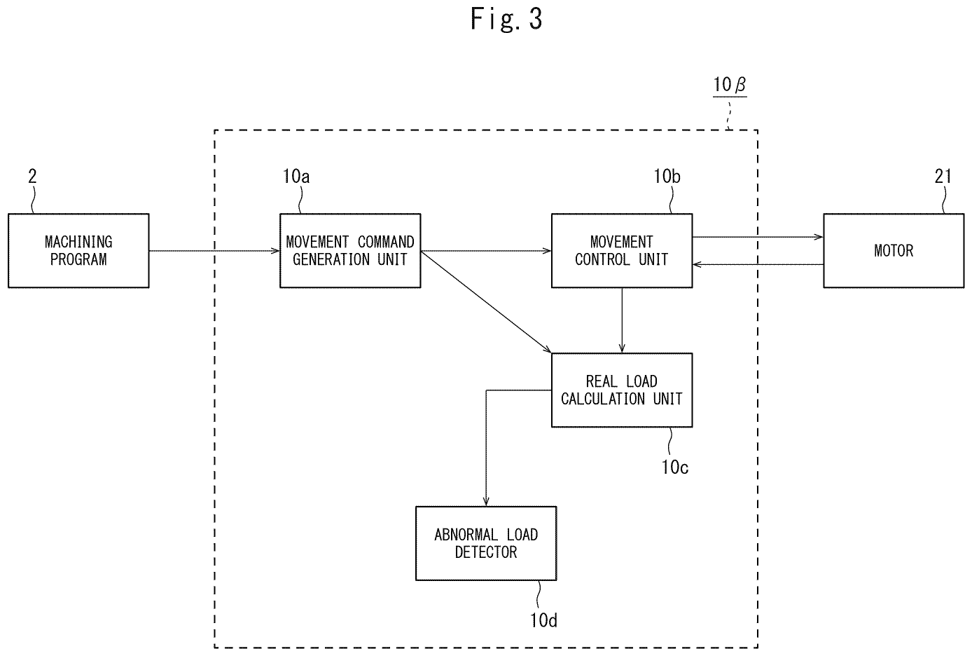

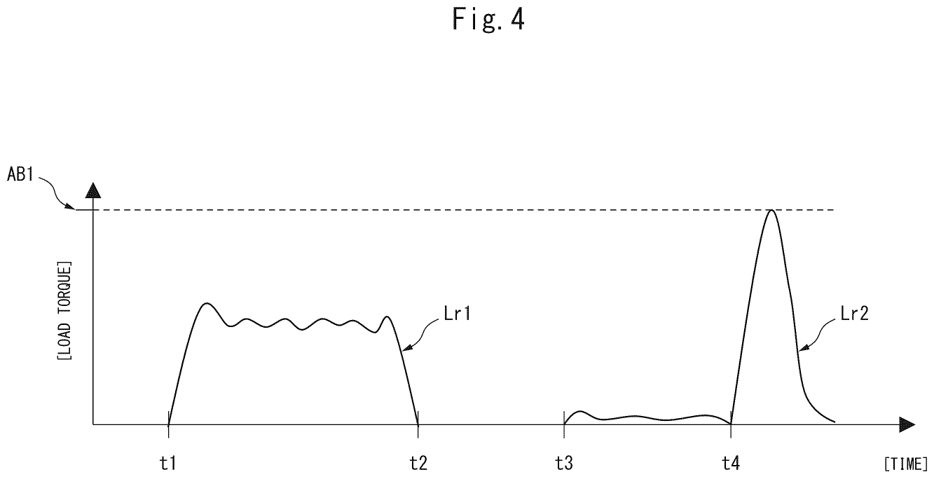

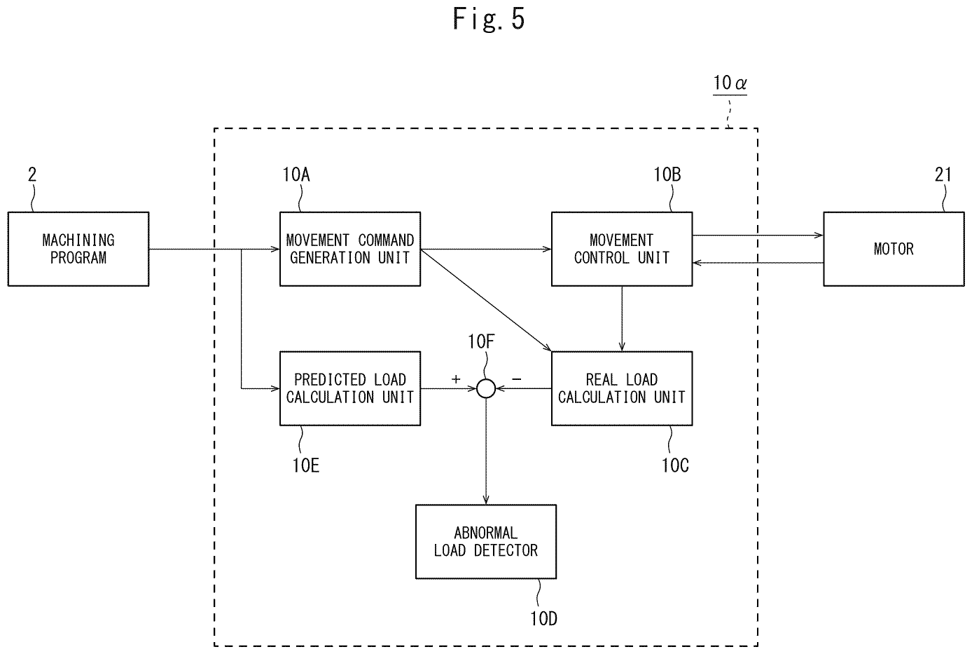

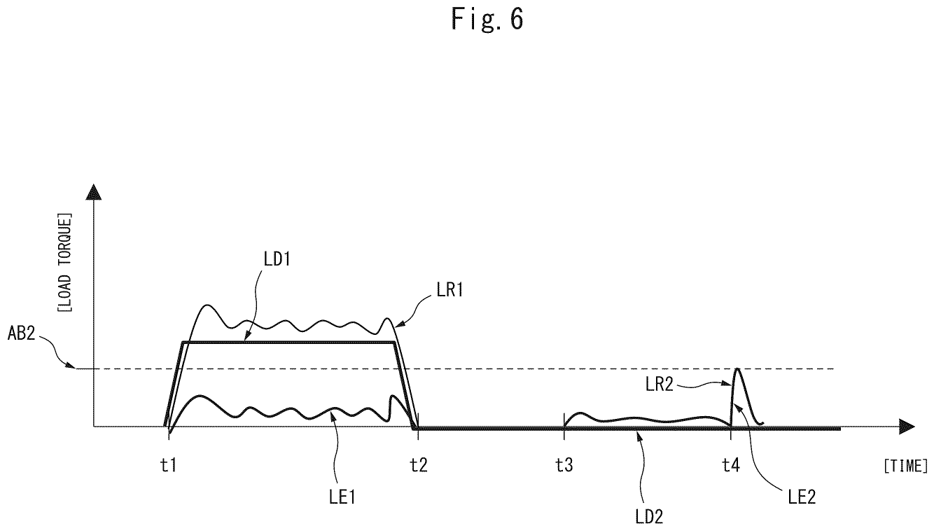

FIG. 3 is a functional block diagram depicting an example of an abnormal load detection device, and FIG. 4 is a diagram for explaining an abnormal load detection by the abnormal load detection device illustrated in FIG. 3. FIG. 3 and FIG. 4 are depicted in comparison with FIG. 5 and FIG. 6 for explaining an example of an abnormal load detection device according to the present embodiment described later. In addition, a machine tool controlled by an abnormal load detection device (numerical control device) may apply a machine tool for cutting a workpiece as an example. Although the abnormal load detection device depicted in FIG. 3 and FIG. 5 illustrates an example integrally configured with the numerical control device, but as described above, it is not limited to be configured integrally.

In FIG. 3, the machining program 2 is stored in the nonvolatile memory (flash memory) 114 described above, for example, and executed by the CPU 111. Further, a numerical control device (abnormal load detection device) 10β controls motors 21 (servomotors 21x, 21y, 21z, 21A, 21B) of the machine tool 20 on the basis of the machining program 2, and detects an abnormal load condition of the axis (motor).

That is, as illustrated in FIG. 3, the abnormal load detection device 100 includes a movement command generation unit 10a, a movement control unit 10b, an actual load calculation unit 10c, and an abnormal load detector 10d. The movement command generation unit 10a generates a movement command for an axis of the machine tool 20 on the basis of the machining program 2, and the movement control unit 10b controls the movement of the axis of the machine tool 20 on the basis of the movement command generated by the movement command generation unit 10a.

The actual load calculation unit 10c receives the movement command from the movement command generation unit 10a, receives the movement control information used for the movement control of the axis of the machine tool 20 from the movement control unit 10b, and calculates an actual load actually applied to the axis of the machine tool 20 on the basis of the movement command and the movement control information. The abnormal load detector 10d detects the abnormal load condition of the axis based on the actual load actually applied to the axis of the machine tool 20 calculated by the actual load calculation unit 10c.

As described above, FIG. 4 is a diagram for explaining abnormal load detection by the abnormal load detection device 10β depicted in FIG. 3, a vertical axis indicates load torque, and a horizontal axis indicates time. In FIG. 4, a curve Lr1 indicates a load characteristic when a workpiece (object) is cut by the machine tool 20, and a curve Lr2 indicates a load characteristic when a collision that is not expected in a state in which the workpiece is driven without cutting processing occurs. Note that the curves Lr1 and Lr2 depict the load characteristics based on the actual load actually applied to the axis of the machine tool 20, which is the output of the actual load calculation unit 10c. In addition, a reference code t1 indicates a point of time when an axis movement of the machine tool 20 is started without cutting the workpiece at the point of time of cutting, t2 indicates an end of cutting, t3 indicates a start of axial movement of the machine tool 20 without cutting the workpiece, and t4 indicates a time when an unexpected collision occurs.

As depicted in the curve Lr1 in FIG. 4, when the workpiece is cut by the machine tool 20, a load torque changes such that the load torque increases with the lapse of time from the cutting disclosure time point t1, and then decreases toward the cutting end time point t2 via a wavy variation period in which the workpiece is cut. At this time, the abnormal load detection by the abnormal load detection device 10β illustrated in FIG. 3 is performed based on, for example, whether the characteristic curve Lr1 of the load torque exceeds a preset threshold (alarm threshold) AB1.

Specifically, the abnormal load detection device 10β depicted in FIG. 3 is configured to detect an abnormal load condition by comparing, for example, a threshold value AB1 obtained by adding a torque value that is considered to be appropriate on the basis of a predetermined offset with respect to a torque value specific to the motor, and an actual torque (characteristic curve Lr1 of a load torque actually applied to the axis of the machine tool 20, which is the output of the actual load calculation unit 10c). That is, when the workpiece is cut by the machine tool 20, as depicted in the curve Lr1 in FIG. 4, the load torque changes so that the load torque increases from the cutting disclosure time point t1 with the lapse of time, and then decreases toward the cutting end time point t2 through a wavy variation period in which the workpiece cutting process is performed. At this time, since the abnormal load detection by the abnormal load detection device 10 illustrated in FIG. 3 is performed based on whether the characteristic curve Lr1 of the load torque exceeds a preset threshold value AB1, for example, it was difficult to set the threshold value AB1 to a small value and detect the abnormal load condition with high sensitivity.

Hereinafter, embodiments of an abnormal load detection device, an abnormal load detection method, and an abnormal load detection program according to the present embodiment will be described in detail with reference to the accompanying drawings. In each drawing, the same or similar elements are denoted by the same or similar reference signs. Further, embodiments described below do not limit the technical scope of the invention described in the claims and the meaning of the term.

FIG. 5 is a functional block diagram depicting an example of an abnormal load detection device according to the present embodiment, and FIG. 6 is a diagram for explaining an abnormal load detection by the abnormal load detection device illustrated in FIG. 5. Note that FIG. 5 and FIG. 6 are depicted by clarifying differences from an example of the abnormal load detection device illustrated in FIG. 3 and FIG. 4 described above. The machine tool controlled by the abnormal load detection device (numerical control device) applies, as an example, a machine tool for cutting a workpiece.

As is clear from the comparison of FIG. 5 and FIG. 3, an abnormal load detection device 10α according to the present embodiment is configured to add a predicted load calculation unit 10E and a difference device 10F to the abnormal load detection device 10β illustrated in FIG. 3. Note that the machining program 2 is stored in, for example, a non-volatile memory 114 in FIG. 2 and executed by the CPU 111. Then, the abnormal load detection device (numerical control device) 10α according to the present embodiment controls the motors 21 (servomotors 21x, 21y, 21z, 21A, 21B) of the machine tool 20 based on the machining program 2, and detects an abnormal load condition of the axis (motor).

Specifically, as illustrated in FIG. 5, the abnormal load detection device 10α includes a movement command generation unit 10A, a movement control unit 10B, an actual load calculation unit 10C, an abnormal load detector 10D, a predicted load calculation unit 10E, and a difference device 10F. The movement command generation unit 10A generates a movement command for the axis of the machine tool 20 on the basis of the machining program 2, and the movement control unit 10B controls the movement of the axis of the machine tool 20 on the basis of the movement command generated by the movement command generation unit 10A.

The actual load calculation unit 10C receives the movement command from the movement command generation unit 10A, receives movement control information used for movement control of the axis of the machine tool 20 from the movement control unit 10B, and calculates an actual load actually applied to the axis of the machine tool 20 on the basis of the movement command and the movement control information. The abnormal load detector 10D detects an abnormal load condition of the axis of the machine tool 20 based on a load prediction error that is an output of the difference device 10F.

The predicted load calculation unit 10E calculates a prediction load applied to an axis on the basis of the machining program 2. The difference device 10F calculates a load prediction error that is a difference between the predicted load on the axis of the machine tool 20 calculated by the predicted load calculation unit 10E and the actual load actually applied to the axis of the machine tool 20 calculated by the actual load calculation unit 10C, and outputs the load prediction error to the abnormal load detector 10D. Note that the predicted load calculation unit 10E performs a simulation based on the machining program 2 to calculate a prediction load. That is, the abnormal load detector 10D detects the abnormal load condition of the axis of the machine tool 20 on the basis of a load prediction error (LE1), which is the difference between a prediction load (LD1) and an actual load (LR1), which are the outputs of the difference device 10F.

As described above, FIG. 6 is a diagram for explaining abnormal load detection by the abnormal load detection device 10α illustrated in FIG. 5, the vertical axis indicates load torque, and the horizontal axis indicates time. In FIG. 6, the curve LR1 indicates a load characteristic (actual load) when a workpiece is cut by the machine tool 20, and the curve LR2 indicates a load characteristic (actual load) when an unexpected collision occurs while the workpiece is driven without cutting the workpiece.

Further, the curve LD1 indicates an output of the predicted load calculation unit 10E when the workpiece is cut by the machine tool 20, that is, a characteristic of a predicted load applied to an axis calculated by carrying out a simulation on the basis of a machining program 2. Similarly, the curve LD2 indicates an output (predicted load) of the predicted load calculation unit 10E when an unexpected collision occurs while the workpiece is driven without being cut. Note that the curve LD2, which is the output of the predicted load calculation unit 10E, is fixed to a fixed value (zero) because there is an unexpected collision.

Further, the curve LE1 indicates an output of the difference device 10F when the workpiece is cut by the machine tool 20, and for example, a relationship of LE1=|LD1−LR1| is satisfied. Since the curve LD2 is fixed to zero, the curve LE2 satisfies the relationship LE2=|LD2−LR2|=LR2. As described above, according to the abnormal load detection device 10α of the present embodiment, the abnormal load detector 10D may improve the detection sensitivity of the abnormal load in order to detect the abnormal load condition of the axis of the machine tool 20 on the basis of the load prediction error (LE1), which is the difference between the prediction load (LD1) and the actual load (LR1), which are the outputs of the difference device 10F That is, in the case where the workpiece is cut by the machine tool 20, as illustrated in the curve LR1 in FIG. 6, the load torque changes so as to increase with the lapse of time from a cutting disclosure time point t1, and then decreases toward a cutting end time point t2 via a wavy variation period in which the workpiece is cut. At this time, the predicted load calculation unit 10E performs simulation on the basis of the machining program 2, calculates a characteristic (LD2) of a prediction load applied to the axis, and the difference device 10F outputs a load prediction error (LE1=|LD1−LR1|), which is a difference between the prediction load and the actual load, to the abnormal load detector 10D.

The abnormal load detector 10D compares a load prediction error (LE 1=|LD1−LR1|), which is an output of the difference device 10F, with a predetermined threshold (alarm threshold) AB2 to detect an abnormal load condition of the axis. As described above, since the abnormal load detection by the abnormal load detection device 10α of the present embodiment illustrated in FIG. 5 is performed based on whether the load prediction error (LE1=|LD1−LR1|) exceeds a preset threshold AB2, the threshold AB2 may be set to a small value, and the abnormal load condition of the axis of the machine tool (20) may be detected with high sensitivity. Note that, for example, the abnormal load detection device 10α may improve the alarm sensitivity by generating an alarm based on the detection of the abnormal load condition.

In the above, for example, the predicted load calculation unit 10E needs to perform simulation on the basis of the machining program 2 to calculate a prediction load, and may calculate a predicted load (predicted cutting load) from a cutting depth, a cutting feed speed, and the like that may be seen from the machining program 2 by directly analyzing the machining program 2 to predict the cutting start time (t1) of the workpiece. Specifically, the predicted cutting load may be calculated as [predicted cutting load]∝[cut depth]×[cutting feed speed].

Separately from the machining program 2, the predicted load calculation unit 10E may receive, for example, the shape information of the workpiece before the start of cutting, and more precisely calculate the predicted cutting load. For example, the size of the original member that shaves the workpiece is given as the coordinates in the machine tool (20), and the calculation of the predicted cutting load by the predicted load calculation unit 10E may be performed more precisely by calculating the positional relationship between the tool position at which the cutting is started, the tool shape, and the first workpiece shape.

Further, for example, when the processing, from the rough (coarse) processing to the finishing processing, is divided into a plurality of processes, the shape information of the workpiece may be obtained from the processing information of the previous step (previous process), and the processing may also be used to calculate the predicted cutting load by the predicted load calculation unit 10E. Specifically, as the processing information, the tool diameter of the tool used before the current processing and the trajectory through which the tool has passed through the workpiece may be used. For example, when processing is performed at a cut depth smaller than the rough processing in the next middle processing after cutting the large portion by the first rough processing, the calculation of the predicted cutting load by the predicted load calculation unit 10E may be performed more precisely by simulating the shape of the finished workpiece surface as a result of the rough processing and calculating which degree of the current cut depth is at each processing position.

Further, when the machine tool repeatedly cuts the same type of workpiece, the actual load information of the workpiece is stored in the memory from the processing information of the previous workpiece, and the actual load information of the stored workpiece and the actual load information of the current workpiece may be compared with each other as it is. As a result, it is possible to more precisely calculate the predicted cutting load by the predicted load calculation unit 10E.

In addition, for example, if the machine tool may measure the workpiece as a pre-processing step, the information measured in the previous step may also be used as the shape information of the workpiece. For example, when a touch probe or a vision sensor or the like is applied, the shape information of the workpiece is acquired using a measurement unit such as a touch probe or a vision sensor, and the shape information of the workpiece may be used to calculate the predicted cutting load by the predicted load calculation unit 10E. For example, when the square workpiece is cut several times on a day by the machine tool, it is difficult to install the square workpiece without violating the square timber (several mm or several degrees of attachment deviation may be generated), so that the mounting position of the workpiece is measured with a touch probe, a vision sensor, or the like every time the unprocessed workpiece is attached, and the prediction error of the simulation due to the attachment error is reduced, so that the prediction cutting load by the predicted load calculation unit 10E may be calculated more precisely.

The value of the predicted cutting load may also be changed (corrected) by the type of the tool, the tool shape, or the material (material of the workpiece) or the like of the material to be cut. For example, since the material of the workpiece has a light cutting load (aluminum) and a heavy cutting (steel), simulation is performed so as to correct the cutting load by the material of the workpiece, thereby more precisely calculating the predicted cutting load by the predicted load calculation unit 10E. It should be noted that the calculation of the predicted cutting load (prediction load) by the predicted load calculation unit 10E is merely an example, and it may be possible to apply various modifications and variations.

In the above, the abnormal load detection method according to the present embodiment may be configured as, for example, an abnormal load detection program executed by the CPU 111 in the numerical control device (abnormal load detection) 10 illustrated in FIG. 2. The abnormal load detection program according to the present embodiment may be stored in, for example, the non-volatile memory 114 in the numerical control device 10 illustrated in FIG. 2.

The abnormal load detection program according to the present embodiment described above may be provided by being recorded in a computer-readable non-temporary recording medium or non-volatile semiconductor storage device and provided, or may be provided via wired or wireless communication. Here, the computer-readable non-transitory recording medium, for example, an optical disk such as a CD-ROM (Compact Disc Read Only Memory), a DVD-ROM, or a hard disk device, and the like may be considered. Further, a PROM (Programmable Read Only Memory), a flash memory, and the like are considered as the non-volatile semiconductor memory. In addition, the distribution from the server device is considered to be provided via a wired or wireless LAN (Local Area Network), or a WAN such as the Internet.

As described in detail above, according to the abnormal load detection device, the abnormal load detection method, and the abnormal load detection program according to the present embodiment, it is possible to improve the detection sensitivity of the abnormal load.

Although the present disclosure has been described in detail, the present disclosure is not limited to the individual embodiments described above. These embodiments may be added, replaced, changed, partially deleted, or the like within a range that does not deviate from the gist of the present disclosure, or within a range that does not deviate from the spirit of the present disclosure derived from the content described in the claims and the equivalents thereof. These embodiments may also be implemented in combination. For example, in the above-described embodiment, the order of each operation and the order of each processing are depicted as an example, and are not limited to these. In addition, the same applies to the case where a numerical value or a mathematical expression is used in the description of the above-described embodiment.

With regard to the above-described embodiments and variations, the following descriptions are further disclosed.

### [Appendix 1]

An abnormal load detection device (10α) for detecting an abnormal load condition of an axis in a machine tool (20) having at least one axis, comprising:
a movement command generation unit (10A) configured to generate a movement command of the axis on the basis of a machining program (2);
a predicted load calculation unit (10E) configured to calculate a prediction load applied to the axis on the basis of the machining program (2);
a movement control unit (10B) configured to control a movement of the axis on the basis of the movement command;
an actual load calculation unit (10C) configured to calculate an actual load actually applied to the axis on the basis of the movement command and movement control information used for a movement control of the axis;
a difference device (10F) configured to calculate a load prediction error that is a difference between the prediction load and the actual load; and
an abnormal load detector (10D) configured to detect an abnormal load condition of the axis on the basis of the load prediction error.

### [Appendix 2]

The abnormal load detection device according to appendix 1, wherein the predicted load calculation unit (10E) performs simulation based on the machining program (2) to calculate the prediction load.

### [Appendix 3]

The abnormal load detection device according to appendix 1 or 2, wherein
the machine tool (20) is a machine tool configured to perform cutting processing on a workpiece, and
the abnormal load detection (10α) device detects an abnormal load state of a cutting axis.

### [Appendix 4]

The abnormal load detection device according to appendix 3, wherein the predicted load calculation unit (10E) calculates a predicted cutting load from a cutting depth and a cutting feed rate based on the machining program (2).

[Appendix 5]

The abnormal load detection device according to appendix 3 or 4, wherein the predicted load calculation unit (10E) receives, in advance, shape information of the workpiece before the start of cutting, separately from the machining program (2), and more precisely calculates a predicted cutting load.

### [Appendix 6]

The abnormal load detection device according to any one of appendixes 3 to 5, wherein the predicted load calculation unit (10E) receives shape information of the workpiece from machining information of an immediately preceding process and uses the machining information to calculate a predicted cutting load, when machining is divided into several processes from rough machining to finishing machining.

### [Appendix 7]

The abnormal load detection device according to any one of appendixes 3 to 6, wherein the predicted load calculation unit (10E) stores actual load information of the workpiece in a memory from machining information of a previous workpiece, and more precisely calculates a predicted cutting load by comparing the actual load information stored in the memory with actual load information of a current workpiece, when the machine tool (20) repeatedly cuts the same type of workpiece.

### [Appendix 8]

The abnormal load detection device according to any one of appendixes 3 to 7, wherein the predicted load calculation unit (10E) uses information measured in the previous step as the shape information of the workpiece when the workpiece is measured as a pre-processing step of the machine tool (20).

### [Appendix 9]

The abnormal load detection device according to appendix 8, wherein measurement of the workpiece is performed by applying a touch probe or a vision sensor.

### [Appendix 10]

The abnormal load detection device according to any one of appendixes 3 to 9, wherein the predicted load calculation unit (10E) corrects a value of a predicted cutting load on the basis of at least one of a type of tool, a tool shape, and a material of the workpiece.

### [Appendix 11]

The abnormal load detection device according to any one of appendixes 1 to 10, wherein the abnormal load detection device is configured integrally with a numerical control device configured to control the machine tool (20).

[Appendix 12] An abnormal load detection method for detecting an abnormal load condition of an axis in a machine tool (20) having at least one axis, comprising:
a movement command generation step of generating a movement command of the axis on the basis of a machining program (2);
a prediction load calculation step of calculating a prediction load applied to the axis on the basis of the machining program (2);
a movement control step of controlling a movement of the axis on the basis of the movement command;
an actual load calculation step of calculating an actual load actually applied to the axis on the basis of the movement command and movement control information used for a movement control of the axis;
a differential calculating step of calculating a load prediction error that is a difference between the prediction load and the actual load; and
an abnormal load detection step of detecting an abnormal load condition of the axis on the basis of the load prediction error.

### [Appendix 13]

An abnormal load detection program for detecting an abnormal load condition of an axis in a machine tool (20) having at least one axis, the abnormal load detection program causing an arithmetic processing unit to execute:
a movement command generation step of generating a movement command of the axis on the basis of a machining program (2);
a prediction load calculation step of calculating a prediction load applied to the axis on the basis of the machining program (2);
a movement control step of controlling a movement of the axis on the basis of the movement command;
an actual load calculation step of calculating an actual load actually applied to the axis on the basis of the movement command and movement control information used for a movement control of the axis;
a differential calculating step of calculating a load prediction error that is a difference between the prediction load and the actual load; and
an abnormal load detection step of detecting an abnormal load condition of the axis on the basis of the load prediction error.

### REFERENCE SIGNS LIST

2 Machining Program
10, 10α, 10β Abnormal Load Detection Device (Numerical Control Device)
10A, 10a Movement Command Generation Unit
10B, 10b Movement Control Unit
10C, 10c Real Load Calculation Unit
10D, 10d Abnormal Load Detector
10E Predicted Load Calculation Unit
10F Difference Device
11 Axis Drive Control Unit
12 Data Acquisition Unit
13 Display Unit
20 Machine Tool
21, 21x, 21y, 21z, 21A, 21B Motor (Servo Motor)
22x, 22y, 22z, 22A, 22B Position Detection Device
111 CPU
112 ROM
113 RAM
114 Non-Volatile Memory (Flash Memory)
115 Graphic Control Circuit
116 Display Device
117 Keyboard
118 Axis Control Circuit
119 Servo Amplifier
122 PMC
123 Software Key
125 Display Device/MDI Panel
124 I/O (Interface)

1. An abnormal load detection device for detecting an abnormal load condition of an axis in a machine tool having at least one axis, comprising:
a movement command generation unit configured to generate a movement command of the axis on the basis of a machining program;
a predicted load calculation unit configured to calculate a prediction load applied to the axis on the basis of the machining program;
a movement control unit configured to control a movement of the axis on the basis of the movement command;
an actual load calculation unit configured to calculate an actual load actually applied to the axis on the basis of the movement command and movement control information used for a movement control of the axis;
a difference device configured to calculate a load prediction error that is a difference between the prediction load and the actual load; and
an abnormal load detector configured to detect an abnormal load condition of the axis on the basis of the load prediction error.

2. The abnormal load detection device according to claim 1, wherein the predicted load calculation unit performs simulation based on the machining program to calculate the prediction load.

3. The abnormal load detection device according to claim 1, wherein
the machine tool is a machine tool configured to perform cutting processing on a workpiece, and
the abnormal load detection device detects an abnormal load state of a cutting axis.

4. The abnormal load detection device according to claim 3, wherein the predicted load calculation unit calculates a predicted cutting load from a cutting depth and a cutting feed rate based on the machining program.

5. The abnormal load detection device according to claim 3, wherein the predicted load calculation unit receives, in advance, shape information of the workpiece before the start of cutting, separately from the machining program, and more precisely calculates a predicted cutting load.

6. The abnormal load detection device according to claim 3, wherein the predicted load calculation unit receives shape information of the workpiece from machining information of an immediately preceding process and uses the machining information to calculate a predicted cutting load, when machining is divided into several processes from rough machining to finishing machining.

7. The abnormal load detection device according to claim 3, wherein the predicted load calculation unit stores actual load information of the workpiece in a memory from machining information of a previous workpiece, and more precisely calculates a predicted cutting load by comparing the actual load information stored in the memory with actual load information of a current workpiece, when the machine tool repeatedly cuts the same type of workpiece.

8. The abnormal load detection device according to claim 3, wherein the predicted load calculation unit uses information measured in the previous step as the shape information of the workpiece when the workpiece is measured as a pre-processing step of the machine tool.

9. The abnormal load detection device according to claim 8, wherein measurement of the workpiece is performed by applying a touch probe or a vision sensor.

10. The abnormal load detection device according to claim 3, wherein the predicted load calculation unit corrects a value of a predicted cutting load on the basis of at least one of a type of tool, a tool shape, and a material of the workpiece.

11. The abnormal load detection device according to claim 1, wherein the abnormal load detection device is configured integrally with a numerical control device configured to control the machine tool.

12. An abnormal load detection method for detecting an abnormal load condition of an axis in a machine tool having at least one axis, comprising:
a movement command generation step of generating a movement command of the axis on the basis of a machining program;
a prediction load calculation step of calculating a prediction load applied to the axis on the basis of the machining program;
a movement control step of controlling a movement of the axis on the basis of the movement command;
an actual load calculation step of calculating an actual load actually applied to the axis on the basis of the movement command and movement control information used for a movement control of the axis;
a differential calculating step of calculating a load prediction error that is a difference between the prediction load and the actual load; and
an abnormal load detection step of detecting an abnormal load condition of the axis on the basis of the load prediction error.

13. A computer readable non-transitory tangible medium for storing an abnormal load detection program for detecting an abnormal load condition of an axis in a machine tool having at least one axis, the abnormal load detection program causing an arithmetic processing unit to execute:
a movement command generation step of generating a movement command of the axis on the basis of a machining program;
a prediction load calculation step of calculating a prediction load applied to the axis on the basis of the machining program;
a movement control step of controlling a movement of the axis on the basis of the movement command;
an actual load calculation step of calculating an actual load actually applied to the axis on the basis of the movement command and movement control information used for a movement control of the axis;
a differential calculating step of calculating a load prediction error that is a difference between the prediction load and the actual load; and
an abnormal load detection step of detecting an abnormal load condition of the axis on the basis of the load prediction error.
